(19) United States
(12) Patent Application Publication
(10) Pub. No.: US 2018/0147789 A1
(43) Pub. Date: May 31, 2018

(54) Rotary Hot Plate Welding System and Method

(71) Applicant: Dukane IAS, LLC, St. Charles, IL (US)

(72) Inventor: Paul H. Cathcart, St. Charles, IL (US)

(21) Appl. No.: 15/363,364

(22) Filed: Nov. 29, 2016

(51) Int. Cl. B29C 65/40; B29C 65/78

(52) U.S. Cl. CPC B29C 65/40; B29C 65/7885

(57) ABSTRACT

A rotary hot plate welding system joins portions of two parts made of thermoplastic material by inserting the two parts into a clamping mechanism with the two parts spaced from each other. The clamping mechanism is mounted on a turntable that is rotatable around an axis that is parallel to the direction of movement of the parts when they are moved to clamp them together. By indexing the turntable, the two parts are moved into alignment with at least one stationary heated plate extending between the two parts to be joined, to melt the opposed surfaces of the two parts. The turntable is then indexed to a station where the melted surfaces of the two parts are clamped together to press the melted surfaces into direct contact with each other. The two parts are cooled while they remain clamped together, in direct contact with each other.

### FIELD OF THE INVENTION

This invention relates generally to hot plate welding of thermoplastic materials and, more particularly, to a rotary hot plate welding system and method.

### BACKGROUND

The process of hot plate welding uses a heated plate to melt the joining surfaces of the two thermoplastic parts. The part halves are brought into contact with a precisely heated platen for a predetermined period. After the plastic interfaces have melted, the parts are brought together to form a molecular, permanent and often hermetic bond. A properly designed joint welded under precise process control often equals or exceeds the strength of any other part area. A nonstick coating, such as Teflon or chrome, is often applied to the tooling to keep the melted plastic from sticking.

### SUMMARY

In accordance with one embodiment, a rotary hot plate welding system is provided for joining portions of two parts made of thermoplastic material by inserting the two parts into one of multiple clamping mechanisms that initially hold the parts spaced from each other. The clamping mechanisms are mounted on a turntable that is rotatable around an axis that is parallel to the direction of movement of the parts when they are clamped together by the clamping mechanism. By indexing the turntable, the two parts are moved to at least one stationary heating element extending over a portion of the turntable and between the two parts to be joined, to melt the opposed surfaces of the two parts. Continued indexing of the turntable moves the two parts away from the heating element. The two parts are then clamped together by moving at least one of the parts in a direction parallel to the axis of rotation of the turntable, so that the two parts directly contact each other. The two parts are cooled while they remain clamped together, in direct contact with each other, to solidify the molten thermoplastic material and thus weld the two parts together. The welded parts are then removed from the turntable.

The rotatable turntable includes multiple clamping mechanisms so that multiple pairs of thermoplastic parts can be carried by the turntable at the same time and processed in seriatim through successive stages of the welding process. This permits high production rates to be achieved.

The turntable is preferably indexed to at least two successive heating stations where the opposed surfaces of the two thermoplastic parts are melted, and then to a clamping station where the parts are pressed together to integrate the melted surfaces. Each heating station preferable includes two separate heating elements, each of which heats one of the parts. For example, the heating elements may be plates that are substantially parallel to the direction of movement of the turntable, and are located between the opposed surfaces of the parts, so that successive pairs of the parts can be moved into alignment with the plates by indexing the turntable.

### BRIEF DESCRIPTION OF THE DRAWINGS

FIG. 1 is a perspective view of a portion of a hot plate welding system embodying the present invention.

FIG. 2 is a simplified top plan view of the system shown in FIG. 1.

FIG. 3 is an enlarged side elevation of one of the heating stations in the system of FIGS. 1 and 2, illustrating the lower fixture of the clamping mechanism in a first elevated position in broken lines.

FIG. 4 is an enlarged side elevation of the clamping station in the system of FIGS. 1 and 2, illustrating the lower fixture of the clamping mechanism in a second elevated position in broken lines.

### DETAILED DESCRIPTION OF ILLUSTRATED EMBODIMENTS

Although the invention will be described in connection with certain preferred embodiments, it will be understood that the invention is not limited to those particular embodiments. On the contrary, the invention is intended to cover all alternatives, modifications and equivalent arrangements as may be included within the spirit and scope of invention as defined by the appended claims.

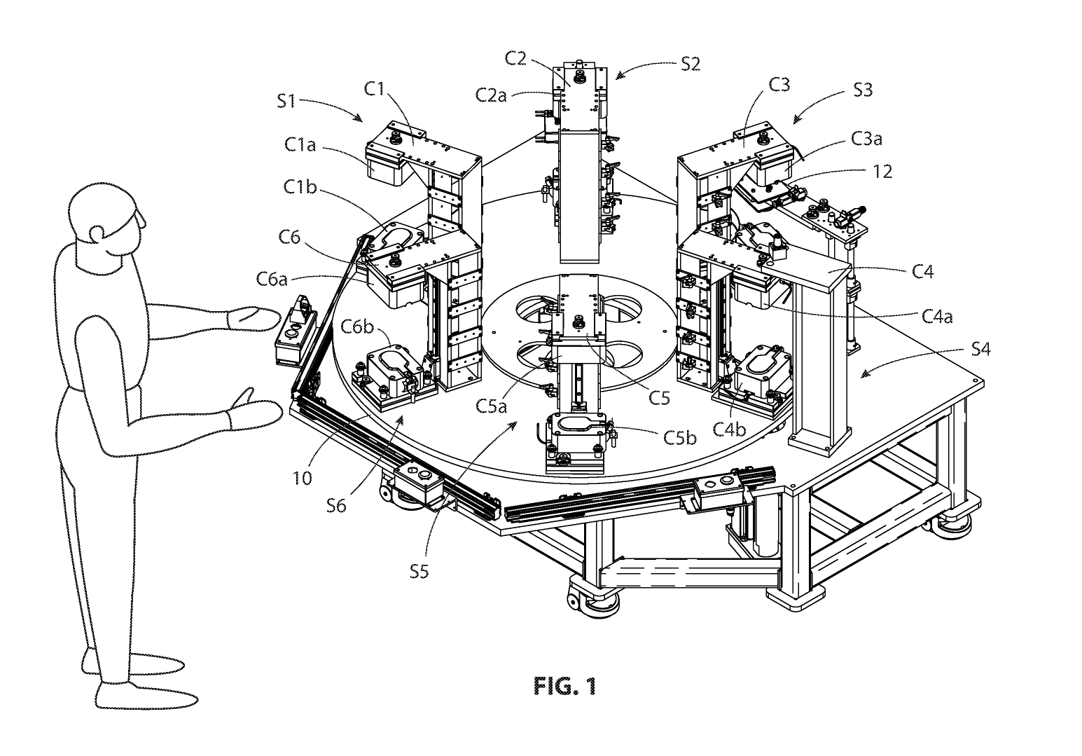

In the embodiment illustrated in FIG. 1, a rotatable turntable 10 has six clamping assemblies C1-C6, each of which includes upper and lower fixtures, such as the fixtures C1a and C1b in the clamping assembly C1. The upper and lower fixtures in each clamping assembly carry a pair of thermoplastic parts P1 and P2 to be welded to each other. Each of the fixtures includes multiple suction cups coupled to a vacuum system to hold the parts P1 and P2 securely on the fixtures while the parts are heated and welded to each other as they are transported sequentially through the six stations S1-S6 by the turntable 10.

As the turntable 10 is rotated, each of the clamping assemblies C1-C6 is aligned successively with six different stations S1-S6 spaced around the circumference of the turntable. This enables six different pairs of parts P1, P2 to be carried by the rotatable turntable at the same time.

The first station S1 is a loading station where the thermoplastic parts P1 and P2 are loaded into one of six clamping assemblies C1-C6, and the last station S6 is an unloading station where the welded parts are removed from a clamping assembly. Stations S2 and S3 are heating stations where the opposed surfaces of the thermoplastic parts P1, P2 are heated by stationary heating plates 11a, 11b and 12a, 12b that extend laterally into the space between the parts P1, P2 as the turntable 10 is rotated. The heating plates are supported by a pair of posts 13a and 13 b at each of the stations S2 and S3. When the lower fixture (e.g., C1b) is in its partially elevated position (described below), the upper heating plates 11a and 12a are spaced slightly below the upper part P1, and the lower heating plates 12a, 12b are spaced slightly above the lower part P2.

Station S4 is a cooling station where the parts cool and solidify while remaining clamped together, and station S5 is an inspection station. In an alternative embodiment, station S5 is used as a third heating station, rather than an inspection station, so that the number of welded parts produced per unit time can be further increased by reducing the dwell time at each station.

The turntable 10 is rotated intermittently in 60-degree increments, so that each clamping assembly passes successively through the six stations S1-S6 in each 360-degree revolution of the turntable. The turntable stops briefly each time the six clamping assemblies C1-C6 are aligned with the six stations S1-S6. The clamping assemblies thus remain aligned with the stations S1-S6 for a fixed dwell time before the turntable is advanced another 60 degrees. In the illustrative embodiment, with two heating stations and a heating time of 10 seconds per station, the thermoplastic parts are heated for a total of 20 seconds (10 seconds at station S2 and 10 seconds at station S3), which is sufficient time to melt the opposed surfaces of the thermoplastic parts. At least the opposed surface portions of the parts P1 and P2 are preferably made entirely of thermoplastic material so that the entirety of these surface portions are melted quickly, and form a strong weld joint when cooled and solidified.

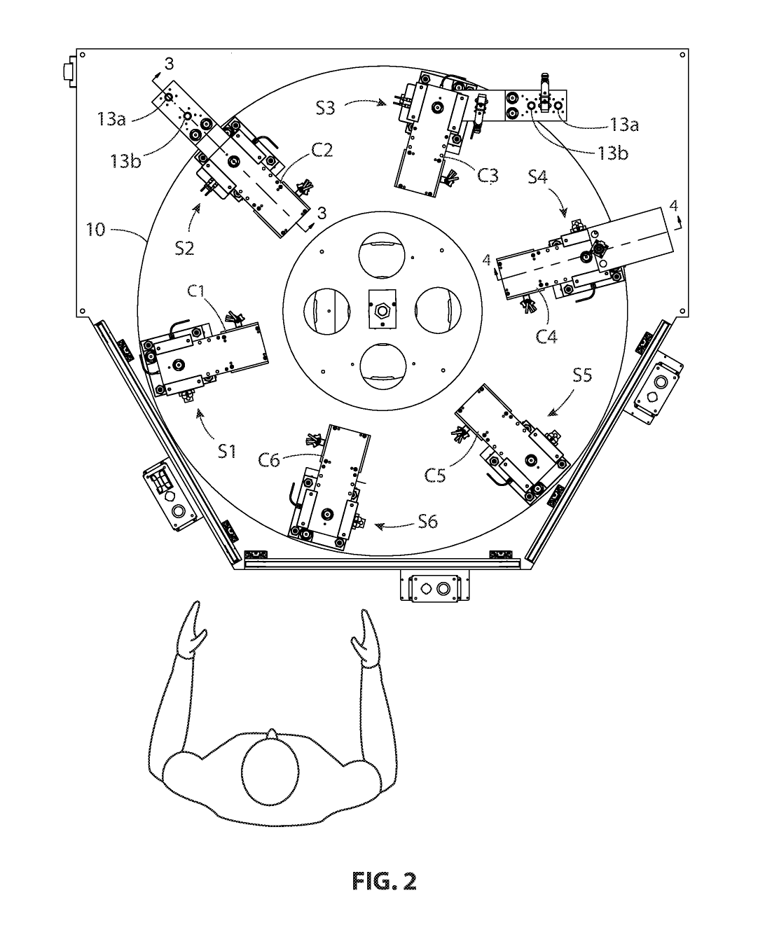

In the embodiment illustrated in FIGS. 1-4, only the lower fixture of each clamping assembly is movable vertically to (a) move the lower thermoplastic part P2 upwardly to a first elevated position to be closer to the heating plates 11 and 12 at stations S2 and S3, (b) move the lower thermoplastic part P2 upwardly to a second elevated position where the lower part P2 is pressed into engagement with the upper thermoplastic part P1 after the opposed surfaces of those parts have been melted, and (c) move the lower fixture downwardly away from the welded product to its home position at the inspection station S5, to permit removal of the welded product from the machine.

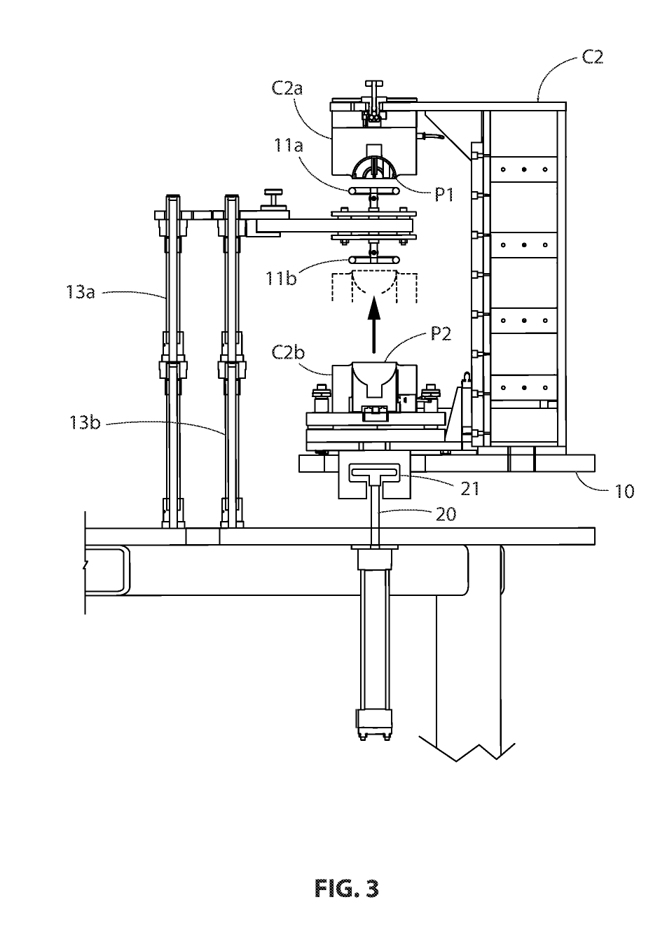

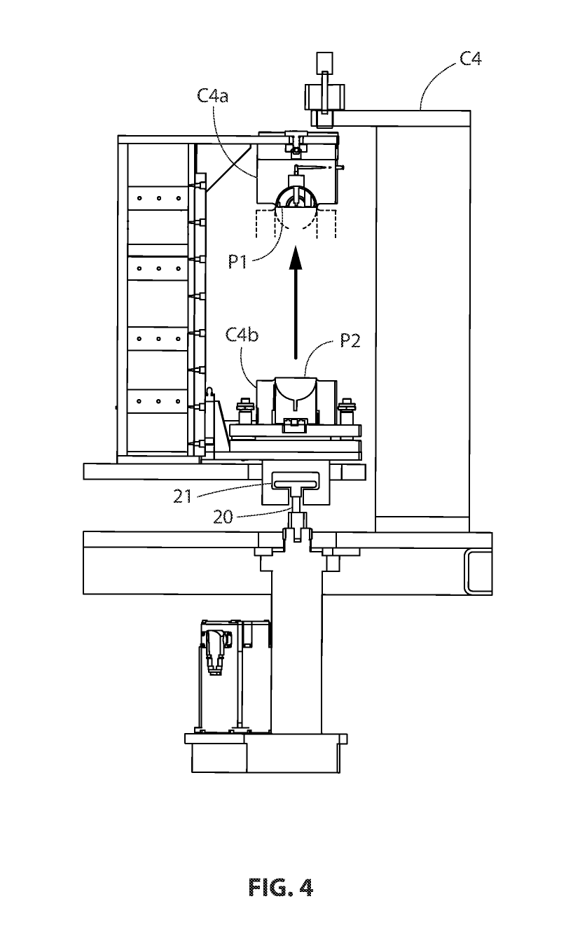

Vertical movement of the lower fixtures is preferably controlled by a single, servo-controlled actuator 20 that is coupled to each successive lower fixture by a slip joint that allows the actuator and each successive fixture to engage and disengage smoothly and accurately. This servo-controlled actuator 20 is illustrated in FIGS. 3 and 4.

FIG. 3 illustrates the actuator 20 moving the lower fixture C1a from its lowermost (home) position to a first elevated position where the lower part P2 is spaced slightly below the lower heating plate 11. The upper part P1 is spaced the same distance above the upper heating plate 12, so both parts are quickly heated to soften the thermoplastic material. The heating plates 11a, 12a and 11b, 12b are preferably heated electrically to a controlled temperature that is high enough to melt the opposed surfaces of the parts P1 and P2 by radiant heating, i.e., the thermoplastic parts P1 and P2 are heated directly by heat radiated from the heating plates. Alternatively, conventional heaters may be used. Although the thermoplastic material is melted by the radiant heating, surface tension causes the molten material to remain on the thermoplastic parts P1 and P2 held in the fixtures. When the molten surfaces are pressed together at station S4, the molten surfaces become integrated with each other so that the two parts become welded to each other when subsequently solidified by cooling.

FIG. 4 illustrates the actuator 20 moving the lower fixture C1a from its lowermost (home) position to a second elevated position where the lower part P2 is pressed firmly against the upper part P1 so that the melted surfaces of the two parts P1 and P2 become integrated with each other.

The actuator 20 returns the lower fixture to its lowermost (home) position at the end of each dwell interval, before the turntable is indexed to its next position. The upper end of the actuator 20 is T-shaped to slide within complementary T-shaped slots 21 in the lower fixture each time the turntable is indexed. This permits a single actuator 20 at each of the stations S2, S3 and S4 to service all six clamping assemblies C1-C6 as the turntable 10 is indexed.

At the cooling station S4, the parts with the melted surfaces remain clamped tightly together while they cool and solidify in the absence of the radiant heating, and they remain clamped while they are inspected at station S5. Thus, the weld is completed by allowing the parts P1 and P2 to cool under pressure, thereby solidifying the thermoplastic material that was melted in the heating stations S2 and S3. The final welded product is unclamped by upward movement of the upper fixture, and is then unloaded at station S6. In the present example a welded product is unloaded every 10 seconds.

While particular embodiments and applications of the present invention have been illustrated and described, it is to be understood that the invention is not limited to the precise construction and compositions disclosed herein and that various modifications, changes, and variations can be apparent from the foregoing descriptions without departing from the spirit and scope of the invention as defined in the appended claims.

1. A rotary hot plate welding method for joining portions of two parts made of thermoplastic material, said method comprising
inserting the two thermoplastic parts into one of multiple clamping mechanisms, with the two parts spaced from each other, said clamping mechanism being mounted on a turntable that is rotatable around an axis that is parallel to the direction of movement of said parts when they are pressed together,
melting the opposed surfaces of said parts by moving the spaced parts, by indexing said turntable, to at least one stationary heating element extending over a portion of said turntable and between the two parts to be joined,
moving the two parts away from said heating element, by rotating said turntable,
clamping the two parts together by moving at least one of said parts in a direction parallel to the axis of rotation of said turntable, to press the melted surfaces of said parts into direct contact with each other,
cooling the two parts while they remain clamped together, in direct contact with each other, to solidify the molten thermoplastic material and thus weld the two parts together, and
removing the welded parts from said clamping mechanism.

2. The method of claim 1 in which said turntable is indexed to at least two successive heating stations where the opposed surfaces of said two thermoplastic parts are melted, and then to a clamping station where said parts are pressed together to integrate said melted surfaces.

3. The method of claim 2 in which said opposed surfaces of said thermoplastic parts are heated by two separate stationary heating elements at each of said heating stations.

4. The method of claim 3 in which both of said heating elements are plates that are substantially parallel to the direction of movement of said turntable, and are located between said opposed surfaces of said parts, so that successive pairs of said parts can be moved into alignment with said plates by indexing said turntable.

5. The method of claim 1 in which said molten surfaces of said parts are pressed together by advancing one of said parts toward the other of said parts in a direction parallel to the axis of rotation of said turntable.

6. The method of claim 1 in which the opposed surface portions of said two parts that are melted are made entirely of thermoplastic material.

7. The method of claim 1 in which said heating elements are radiant heaters

8. A rotary hot plate welding system for joining portions of two parts made of thermoplastic material, said system comprising
multiple clamping mechanisms mounted on a turntable that is rotatable around an axis, each of said clamping mechanisms receiving a pair of said parts and holding the two parts spaced from each other,
a drive system for indexing said turntable to align said clamping mechanism with successive stations,
at least one stationary heating element extending over a portion of said turntable, and between the two parts held spaced apart by said clamping mechanism, at two or more of said stations to melt the opposed surfaces of said parts, and
an actuator, at each of said stations having a heating element, for moving said heating element into close proximity with the opposed surfaces of said parts,
an actuator at a clamping station downstream of said stations having said heating elements, for moving said opposed surfaces of said parts into pressing engagement to integrate the melted surfaces of said parts, and
an actuator at an unclamping station downstream of said clamping station for moving said clamping mechanism away from one of said parts to permit removal of the integrated parts from said turntable.

9. The rotary hot plate welding system of claim 8 in which said clamping mechanisms are movable in a direction parallel to the axis of rotation of said turntable to press the molten surfaces of said parts together.

10. The rotary hot plate welding system of claim 8 in which said turntable is indexable to a station between said clamping and unclamping stations where the molten surfaces of said parts remain pressed against each other while they cool to solidify the molten thermoplastic material and thus weld the two parts together.

11. The rotary hot plate welding system of claim 10 in which said heating elements are plates that are substantially parallel to the direction of movement of said turntable, and are located between said opposed surfaces of said parts, so that successive pairs of said parts can be moved into alignment with said plates by indexing said turntable.

12. The rotary hot plate welding system of claim 8 in which said molten surfaces of said parts are pressed together by advancing one of said parts toward the other of said parts in a direction parallel to the axis of rotation of said turntable.

13. The rotary hot plate welding system of claim 8 in which the opposed surface portions of said two parts that are melted are made entirely of thermoplastic material.

14. The rotary hot plate welding system of claim 8 in which said heating elements are radiant heaters
